(19) United States
(12) Patent Application Publication
(10) Pub. No.: US 2012/0242091 A1
(43) Pub. Date: Sep. 27, 2012

(54) ECCENTRIC DUAL ROTOR ASSEMBLY FOR WIND POWER GENERATION

(75) Inventors: Byung-Sue Ryu, Seoul (KR); Young-Sil Yu, Seoul (KR)

(73) Assignee: YOUNG-SIL YU, SEOUL (KR)

(21) Appl. No.: 13/395,122

(22) PCT Filed: Feb. 11, 2010
(86) PCT No.: PCT/KR10/00869

§ 371 Date: May 23, 2012

(30) Foreign Application Priority Data
Sep. 10, 2009 (KR) 10-2009-0085230

(51) Int. Cl. F02D 25/00

(52) U.S. Cl. 290/4 D

(57) ABSTRACT

An eccentric dual rotor assembly for wind power generation includes: a supporting structure for rotatably supporting a main shaft; a first rotor including a rotating frame and a plurality of wing assemblies provided on an outer surface of the rotating frame to receive wind and to rotate the rotating frame in the forward direction; a second rotor configured symmetrically to the first rotor and including a rotating frame and a plurality of wing assemblies provided on an outer surface of the rotating frame to receive wind and to rotate the rotating frame in the backward direction; a guide member installed at the front of the main shaft to guide oncoming wind blowing between the first and second rotors to the fronts of the first and second rotors; and power-transmitting means for transmitting kinetic energy generated by the rotation of the first and second rotors to a generating apparatus.

### TECHNICAL FIELD

The present invention relates to a rotor structure for use in a wind power generation apparatus, and more particularly, to an eccentric dual rotor assembly for wind power generation, which includes two rotors symmetrically positioned, with a main shaft being interposed between the two rotors, and a guide member for guiding wind flowing between two rotors to fronts of the two rotors, thereby effectively utilizing wind power.

### BACKGROUND OF THE INVENTION

Since existing fossil energy resources pollute the earth environment, as well as being in danger of running out, scientists from different countries have been eagerly looking for apparatuses capable of utilizing an alternative energy source or a green energy source which does not pollute the environment, without being depleted. Such a green alternative energy source includes solar energy, wind energy, current energy, tidal energy, geo-thermal energy, and bio-thermal energy. A wind power generation apparatus has been used as means for generating electricity by use of the wind energy.

In general, the wind power generation apparatus can be divided into a horizontal-axis wind power generation apparatus having a rotation shaft which is horizontally installed to a ground, and a vertical-axis wind power generation apparatus having a rotation shaft which is vertically installed to the ground. The horizontal-axis wind power generation apparatus is more commonly used, and has an advantage of achieving the high efficiency in generation of electricity. However, there are some drawbacks in that it is difficult to generate the electricity, without a hitch, in a case in which a direction of wind is frequently changed or strong wind such as gust blows; since major components including a rotor are installed at a high position, maintenance is not easy; and it is structurally vulnerable to the strong wind such as a very violent tropical storm.

The vertical-axis wind power generation apparatus has advantages of generating the electricity irrespective of the direction, speed or magnitude of the wind, and easily conducting the maintenance of the major components such as speed increaser or generator. Therefore, many studies of the vertical-axis wind power generation apparatus are in progress.

The vertical-axis wind power generation apparatus includes a cylindrical rotor having a plurality of wings provided at an outer surface of a cylindrical rotating frame to convert wind energy into mechanical energy, and a power generating device receiving the mechanical energy from the rotor and converting it into electrical energy.

FIG. 1 is a plan view illustrating a rotor.

In a case of a cylindrical rotor 10 having a plurality of wings 12 provided at an outer surface of a rotating frame 11, wind power acts on the wing positioned at a side A, in which a turning direction of the rotor is identical to a direction of the wind, to generate a rotational force to thereby turn the rotor. The wing positioned at a side B, in which the turning direction of the rotor is opposite to the direction of the wind, generates a resistance to decrease the rotational force of the rotor.

Since the cylindrical rotor is turned by the wind only blowing toward any one side on the basis of the rotation shaft installed at a center portion of the rotor, there is a problem in that the wind energy is not sufficiently utilized.

### DESCRIPTION OF SPECIFIC EMBODIMENTS

### Technical Problem

Therefore, the present invention has been made to solve the above-mentioned problems occurring in the related art, and an object of the present invention is to provide an eccentric dual rotor structure for wind power generation which can generate a rotational force by use of all wind blowing towards a front of rotors, thereby effectively utilizing wind energy.

Another object of the present invention is to provide an eccentric dual rotor structure for wind power generation which can employ a small rotor on the basis of the same generation capacity, thereby lowering a cost required to manufacture the rotor and easily handling the rotor to improve the productivity.

### Technical Solution

In order to accomplish the above-mentioned objects, there is provided an eccentric dual rotor structure for wind power generation, including: a supporting structure which rotatably supports a main shaft; a first rotor including a cylindrical rotating frame installed to a first rotation shaft which is rotatably supported by a support bar extending from the main shaft, and a plurality of wing assemblies provided on an outer surface of the rotating frame, in which wind power acts on the wing assemblies to rotate the rotating frame in a forward direction; a second rotor having a structure symmetrical to the first rotor, and including a cylindrical rotating frame installed to the second rotation shaft which is rotatably supported by another support bar extending from the main shaft, and a plurality of wing assemblies provided on an outer surface of the rotating frame, in which wind power acts on the wing assemblies to rotate the rotating frame in a reverse direction; a guide member which is installed to the main shaft so as to position in front of the main shaft, in which wind flowing between the first and second rotors is guided to front surfaces of the first and second rotors by the guide member; and a power-transmitting means which transmits power generated by rotation of the first and second rotors to a power generating device.

The guide member is positioned in front of the main shaft, and the first and second rotors are symmetrically placed on the basis of a line connecting a center of the guide member and a center of the main shaft at the rear of the main shaft, so that the guide member and the first and second rotors are turned with the main shaft to change directions of the guide member and the first and second rotors in accordance with a direction of the wind.

The first rotor and the second rotor are connected to each other by a power combining unit to turn in cooperation with each other, and any one of the first and second rotation shafts transmits the power to the power generating device via the power-transmitting means.

In this instance, the power combining unit is a connecting rod or a gear train.

The power-transmitting means includes a first timing pulley installed to the first rotation shaft or the second rotation shaft, a power transmitting shaft which encloses the main shaft to form a dual-shaft structure, is rotated around the main shaft, and is coupled to the power generating device to transmit the power to the power generating device, a second timing pulley provided to the power transmitting shaft, and a timing belt connecting the first and second timing pulley.

The wing assemblies of the first rotor has a plurality of wing fixing portions protruding from the rotating frame, a plurality of resilient wing fixing plates each fixed to the wing fixing portion, and a plurality of wings each fixed to one side of the wing fixing plate at a center portion and an end portion to open or close a space formed between the wing fixing portions, in which one end portion of the wing protrudes outwardly from the rotating frame when the rotating frame is rotated to open the space, and the wing assemblies of the second rotor has a plurality of wing fixing portions protruding from the rotating frame, a plurality of resilient wing fixing plates each fixed to the wing fixing portion, and a plurality of wings each fixed to one side of the wing fixing plate at a center portion and an end portion to open or close a space formed between the wing fixing portions, in which one end portion of the wing protrudes outwardly from the rotating frame when the rotating frame is rotated to open the space.

With the above-described configuration of the present invention, the guide member guides the wind flowing between the first and second rotors to the front of the first and second rotors, so that all wind blowing from the front is utilized to generate a rotational force, thereby effectively utilizing wind energy.

Since all wind blowing from the front is utilized to generate the rotational force, large rotational force can be obtained by even small rotor in comparison with a rotor of a related art, so that a size of the rotor is decreased on the basis of the same generation capacity. Therefore, it is possible to significantly lower a cost required to manufacture the rotor, as well as easily manufacturing and handling the rotor.

### BRIEF DESCRIPTION OF THE DRAWINGS

FIG. 1 is a plan view illustrating a rotor according to a related art.

FIG. 2 is a top view illustrating a dual rotor structure according to a preferred embodiment of the present invention.

FIG. 3 is a front view illustrating the dual rotor structure according to the preferred embodiment of the present invention.

FIG. 4 is a perspective view illustrating a supporting structure according to the present invention.

FIG. 5 is a top view illustrating a first rotor according to the present invention.

FIG. 6 is a partially detailed view illustrating the first rotor according to the present invention.

FIG. 7 is a top view illustrating a second rotor according to the present invention.

FIG. 8 is a partially detailed view illustrating the second rotor according to the present invention.

FIG. 9 is a detailed view illustrating a configuration of a power-transmitting means according to the present invention.

FIG. 10 is a top view illustrating the state in which the first and second rotors are connected to each other by a connecting rod.

FIG. 11 is a top view illustrating the state in which the first and second rotors are connected to each other by a gear train.

FIG. 12 is a top view illustrating a flow state of wind blowing toward an eccentric dual rotor structure according to the present invention.

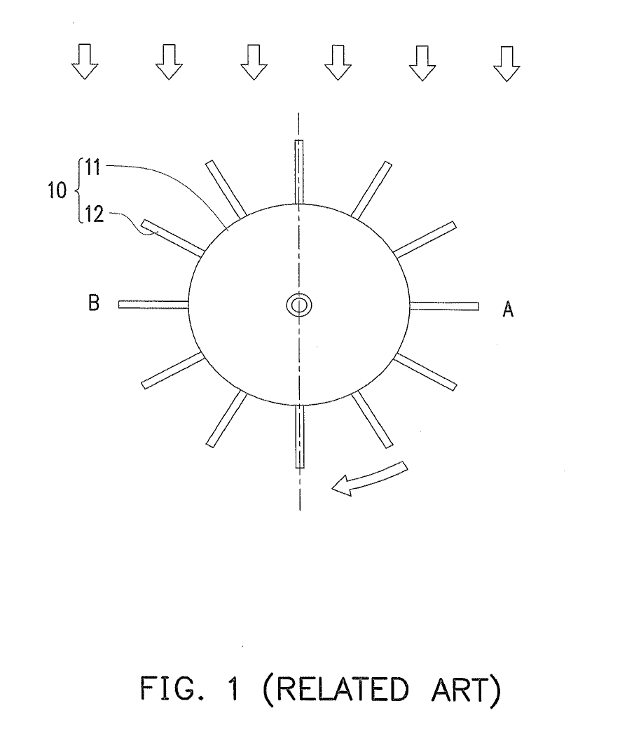

### DESCRIPTION OF REFERENCE NUMERALS FOR MAJOR COMPONENTS IN THE ACCOMPANYING DRAWINGS

110: supporting structure, 111: upper-end portion supporting section
112: lower-end portion supporting section, 113: connection section
120: first rotor, 121: first rotation shaft
122: rotating frame, 123: wing assembly
123a: wing fixing portion, 123b: wing fixing plate
123c: wing, 130: second rotor
131: second rotation shaft, 132: rotating frame
133: wing assembly, 133a: wing fixing portion
133b: wing fixing plate, 133c: wing
140: guide member, 150: power-transmitting means
151: first timing pulley, 152: second timing pulley
153: power transmission shaft, 154: timing belt
160: main shaft, 161: support bar
162: support bar, 180: power combining unit
181: connecting rod, 182: gear train

### DESCRIPTION OF SPECIFIC EMBODIMENTS

Now, preferred embodiment of the present invention will be described in detail with reference to the accompanying drawings.

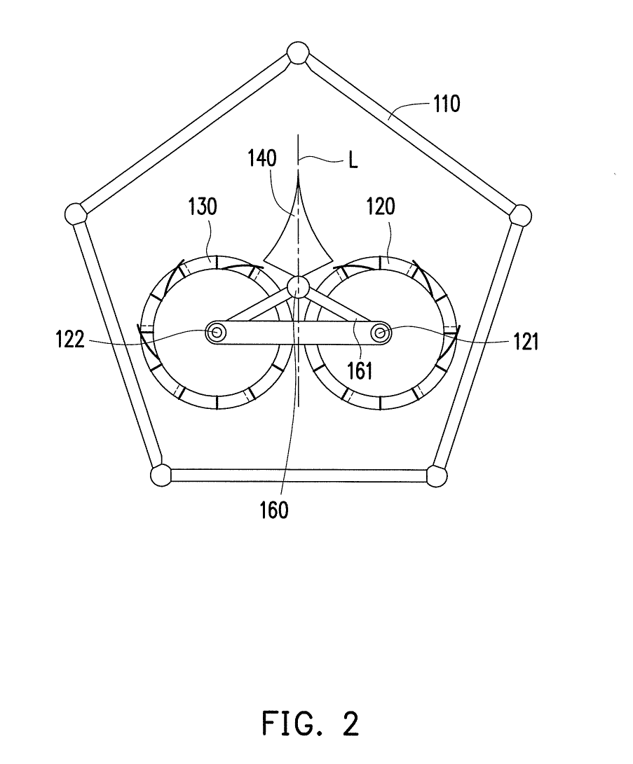

FIG. 2 is a top view illustrating a dual rotor structure according to a preferred embodiment of the present invention.

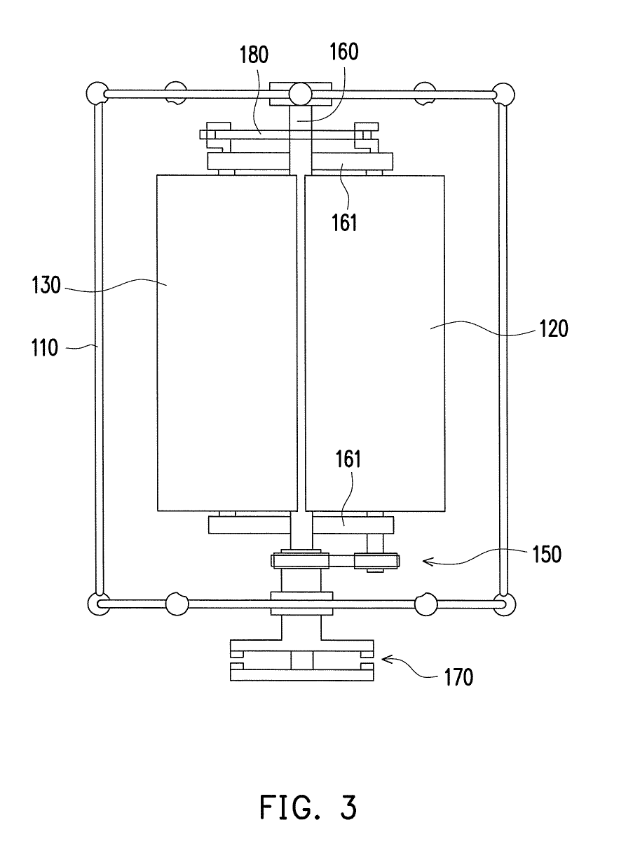

FIG. 3 is a front view illustrating the dual rotor structure according to the preferred embodiment of the present invention.

The eccentric dual rotor structure of the present invention is configured to generate power for wind power generation by means of two rotors, and is characterized by utilizing all wind blowing towards the front of two rotors to generate the power. The eccentric dual rotor structure includes a supporting structure 110, a first rotor 120, a second rotor 130, a guide member 140, and a power-transmitting means 150.

The supporting structure 110 is adapted to rotatably support a main shaft 160 supporting the first and second rotors 120 and 130. The supporting structure 110 may be configured to rotatably support the main shaft 160, with upper and lower end portions of the main shaft 160 being supported by bearings.

The supporting structure 110 may be configured in various structures. The supporting structure 110 is preferably configured to easily secure a space for maintenance of the first and second rotors 120 and 130, as well as stably supporting the main shaft 160 which supports the first and second rotors 120 and 130.

FIG. 4 is a perspective view illustrating the supporting structure according to the present invention.

The supporting structure 110 of the present invention includes an upper-end portion supporting section 111 rotatably supporting the upper end portion of the main shaft 160, a lower-end portion supporting section 112 rotatably supporting the lower end portion of the main shaft 160, and a connection section 113 connecting the upper-end portion supporting section 111 and the lower-end portion supporting section 112.

The upper-end portion supporting section 111 is formed in a plane structure of a regular pentagon having left and right upper sides 111a and 111b, left and right lower sides 111c and 111d, and a base side 111e.

The lower-end portion supporting section 112 is formed in a plane structure of a regular pentagon having left and rights upper sides 112a and 112b, left and right lower sides 112c and 112d, and a base side 112e. The left and right upper sides 112a and 112b of the lower-end portion supporting section 112 are located immediately below the base side 111e of the upper-end support section 111, and the base side 112e of the lower-end portion supporting section 112 is located immediately below the left and right upper sides 111a and 111b of the upper-end portion supporting section 111. As a result, any one side of the upper-end portion supporting section 111 and any one side of the lower-end portion supporting section 112 which is positioned diagonally to the side are maintained in a parallel state to each other. With the above configuration, the upper-end portion support section 111 and the lower-end portion supporting section 122 have an inverted pentagon with respect to each other.

The connection section 113 is adapted to connect the upper-end portion supporting section 111 and the lower-end portion supporting section 112 to connect any one apex of the upper-end portion supporting section 111 and two apexes of the lower-end portion supporting section 112, so that a triangular truss structure is formed at the side of the supporting structure 110.

With the structure of the support framework 110, the first and second rotors 120 and 130 can be stably supported, and if any one side of the upper-end portion supporting section 111 or lower-end portion supporting section 112 is removed to secure the space for the maintenance of the first and second rotors 120 and 130, the main shaft 160 can be stably supported, without collapsing the supporting structure 110. Therefore, convenience can be provided at the time of the maintenance of the rotor structure.

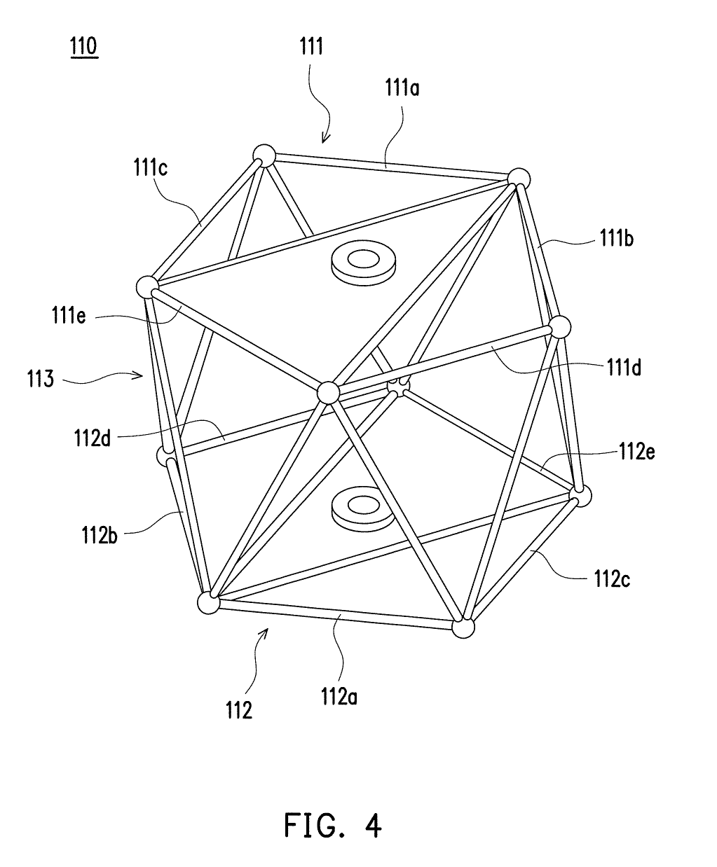

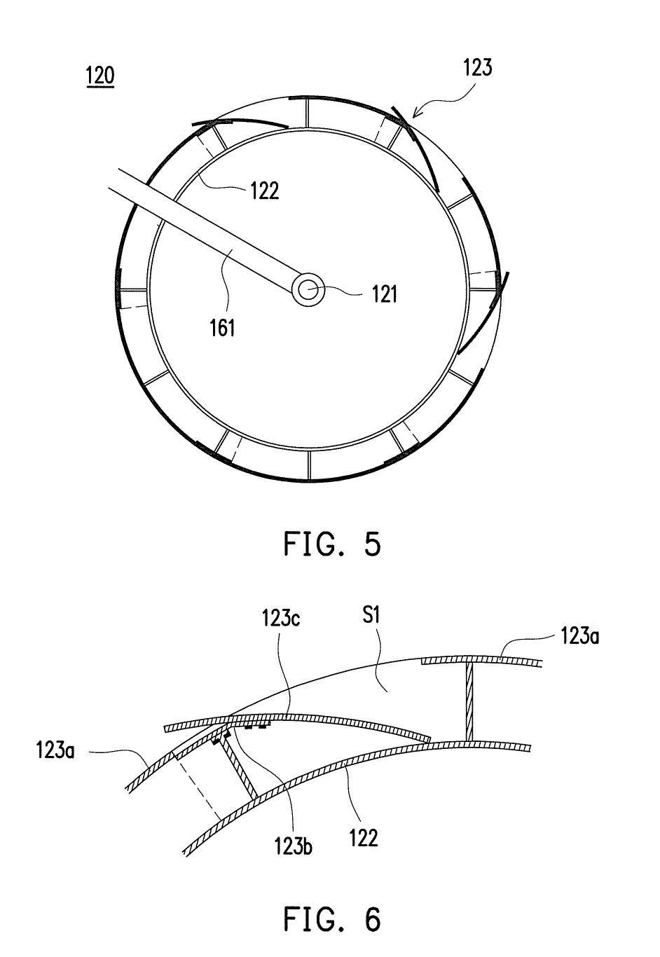

FIG. 5 is a top view illustrating the first rotor according to the present invention. FIG. 6 is a partially detailed view illustrating the first rotor according to the present invention.

The first rotor 120 includes a cylindrical rotating frame 122 installed to the first rotation shaft 121 which is supported by a support bar 161 extending from the main shaft 160, and a plurality of wing assemblies 123 provided on an outer surface of the rotating frame 122, in which wind power acts on the wing assemblies 123 to rotate the rotating frame 122 in a forward direction.

In this instance, the wing assembly 123 has a plurality of wing fixing portions 123a protruding from the outer surface of the rotating frame 122 and positioned at regular intervals, a plurality of resilient wing fixing plates 123b each fixed to the wing fixing portion 123a, and a plurality of wings 123c each fixed to one side of the wing fixing plate 123b at a center portion and an end portion to open or close a space S1 formed between the wing fixing portions 123a. One end portion of the wing 123c protrudes outwardly from the rotating frame 122 when the rotating frame is rotated to open the space S1.

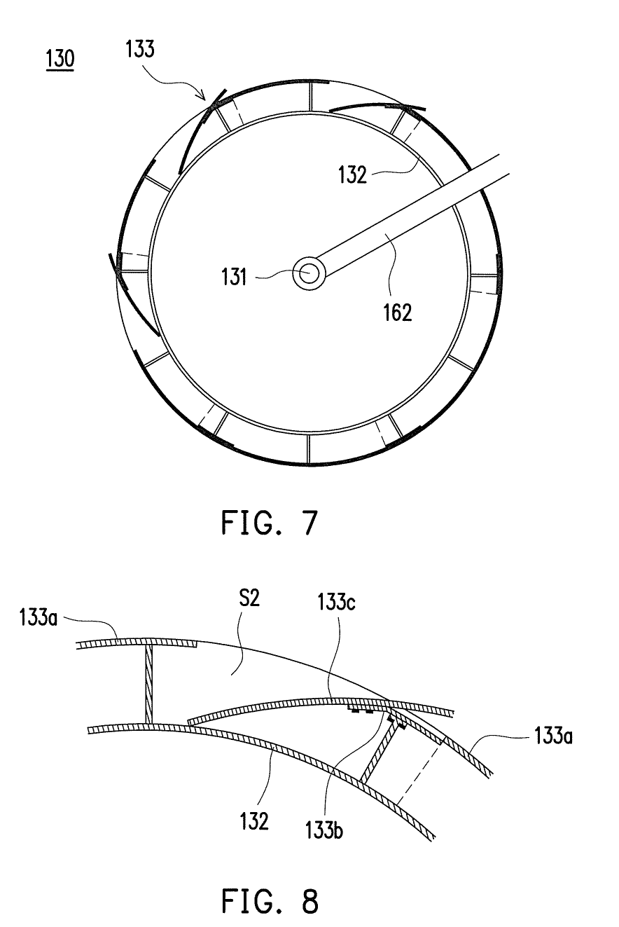

FIG. 7 is a top view illustrating the second rotor according to the present invention. FIG. 8 is a partially detailed view illustrating the second rotor according to the present invention.

The second rotor 130 includes a cylindrical rotating frame 132 installed to the second rotation shaft 131 which is supported by another support bar 162 extending from the main shaft 160, and a plurality of wing assemblies 133 provided on an outer surface of the rotating frame 132, in which wind power acts on the wing assemblies 133 to rotate the rotating frame 132 in a reverse direction. As a result, the second rotor 130 has a structure symmetrical to that of the first rotor 120.

In this instance, the wing assembly 133 has a plurality of wing fixing portions 133a protruding from the outer surface of the rotating frame 132 and positioned at regular intervals, a plurality of resilient wing fixing plates 133b each fixed to the wing fixing portion 133a, and a plurality of wings 133c each fixed to one side of the wing fixing plate 133b at a center portion and an end portion to open or close a space S2 formed between the wing fixing portions 133a. One end portion of the wing 133c protrudes outwardly from the rotating frame 132 when the rotating frame is rotated to open the space S2.

According to the above-described structure of the first rotor 120 and the second rotor 130, when the spaces S1 and S2, on which the wind power acts, are opened, the end portions of the wings 123c and 133c protrudes outwardly from the rotating frames 122 and 132. Since timing for closing the spaces S1 and S2 by the vanes 123c and 133c is delayed, there is an advantage in that the wind power can be further effectively utilized.

Meanwhile, the guide member 140 shown in FIG. 2 guides the wind flowing between the first and second rotors 120 and 130 to the front surfaces of the first and second rotors 120 and 130, that is, a side which receives the wind to generate a rotational force. Therefore, the first and second rotors 120 and 130 utilize all wind blowing from the front.

The guide member 140 is installed to the main shaft 140 so as to position in front of the main shaft 160, and is adapted to turn with the first and second rotors 120 and 130. The guide member 140 is formed in a plane structure, such as a triangle, of which a front end is sharp and a surface area is gradually increased from the front to the rear, thereby dispersing the wind blowing between the first and second rotors 120 and 130 into both sides.

When the first and second rotors 120 and 130 and the guide member 140 are installed to the main shaft 160, the guide member 140 is positioned in front of the main shaft 160, and the first and second rotors 120 and 130 are symmetrically placed on the basis of a line L connecting a center of the guide member 140 and a center of the main shaft 160 at the rear of the main shaft 160. As a result, the guide member 140 and the first and second rotors 120 and 130 are structurally placed in a triangle, and the main shaft 160 is positioned in the triangle formed by the guide member 140 and the first and second rotors 120 and 130.

With the above configuration, the guide member 140, the first and second rotors 120 and 130, and the main shaft 160 are turned by the direction of the wind acting on the guide member 140 and the first and second rotors 120 and 130, so that the direction of the first and second rotors 120 and 130 are changed so as to be against the wind. If the wind blows at the same velocity, the first and second rotors 120 and 130 are applied by high pressure, as compared with the guide member 140, due to the shape difference between the rotors 120 and 130 and the guide member 140. Because of the difference in pressure, the first and second rotors 120 and 130 and the guide member 140 are turned so that the first and second rotors 120 and 130 applied by the high pressure are positioned at the rear of the main shaft 160, while the guide member 140 applied by the low pressure is positioned at the front of the main shaft 160.

In order to describe the position relation between the guide member 140 and the first and second rotors 120 and 130, the term ‘front’ herein means a direction close to the wind flow direction on the basis of the main shaft 130, and the term ‘rear’ means a direction away from the wind flow direction on the basis of the main shaft 130.

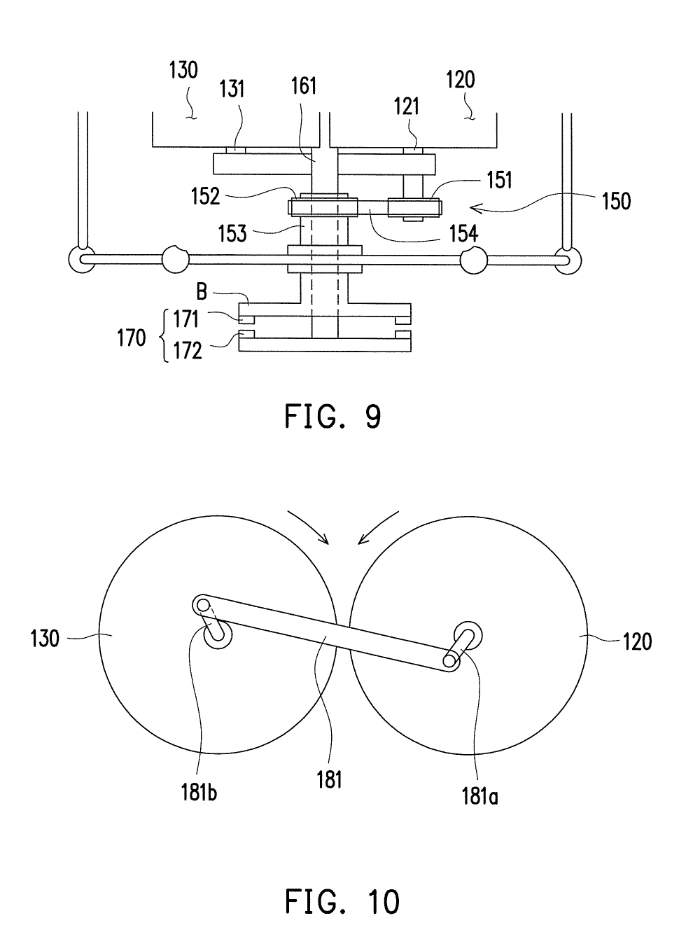

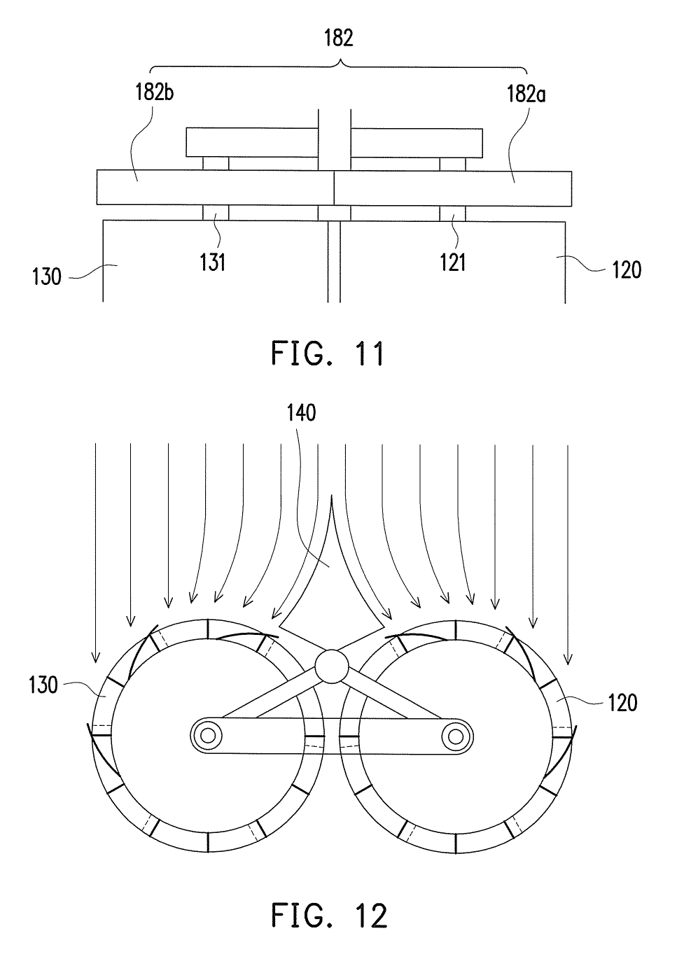

FIG. 9 is a detailed view illustrating a configuration of the power-transmitting means according to the present invention. FIG. 10 is a front view illustrating the state in which the first and second rotors are connected to each other by the connecting rod. FIG. 11 is a top view illustrating the state in which the first and second rotors are connected to each other by a gear train.

The power-transmitting means 150 transmits the power generated by the rotation of the first and second rotors 120 and 130 to a power generating device 170.

In the case in which the first rotor 120 and the second rotor 130 are respectively configured to transmit the power to the power generating device 170 by the power-transmitting means 150, the configuration of the apparatus is complicated, and thus a manufacturing cost is increased. Therefore, it is preferable that the first and second rotors 120 and 130 are turned in cooperation with each other, and the power is transmitted to the power generating device 170 via any one of the rotors only.

In order to turn the first and second rotors 120 and 130 in cooperation with each other, the first and second rotors 120 and 130 are connected to each other by a power combining unit 180.

The power combining unit 180 may include a connecting rod 181 or gear train 182. The connecting rod 181 has one end portion extending to the upper portion of the first rotation shaft 121 and coupled to a bent shaft 181a, and the other end portion extending to the upper portion of the second rotation shaft 131 and coupled to other bent shaft 181b. With the above configuration, when any one of the rotors is turned by the wind, the position of the connecting rod 181 is shifted. Since the position displacement of the connecting rod 181 is transmitted to the other rotor via the rotation shaft, the first and second rotors 120 and 130 are turned in cooperation with each other.

The gear train 182 has a first gear 182a and a second gear 182b which are respectively installed to the first rotation shaft 121 and the second rotation shaft 131 in such a manner that the gears are meshed with each other.

As described above, in the case in which the first and second rotors 120 and 130 are turned in cooperation with each other, the power-transmitting means 150 includes a first timing pulley 151 installed to the first rotation shaft 121 or the second rotation shaft 131, a power transmitting shaft 153 enclosing the main shaft 160 to form a dual-shaft structure, being rotated around the main shaft, and coupled to the power generating device to transmit the power to the power generating device, a second timing pulley 152 provided to the power transmitting shaft 153, and a timing belt 154 connecting the first and second timing pulley 151 and 152.

The coupling of the power generating device 170 and the power transmitting shaft 153 may be achieved by coupling the power transmitting shaft 153 and a generator known in the art via a mechanical element for power transmission, such as belt, chain or gear. Alternatively, as Korean Patent Registration No. 10-0743475, entitled Variable Electricity Generation Apparatus for Wind Power Generator,' assigned to the applicant, the power transmitting shaft 153 may be directly coupled to the power generating device 170 by installing a number of magnets 171 to the power transmitting shaft 153 by use of a separate bracket B to rotate the magnets 171 together with the power transmitting shaft 153, and installing a plurality of coils 172 corresponding to the plurality of magnets 171 adjacent to the magnets by use of the supporting structure 110, so that the power transmitting shaft 153 can be directly connected to the power generating device 170.

FIG. 12 is a top view illustrating a flow state of the wind blowing toward the eccentric dual rotor structure according to the present invention.

With the eccentric dual rotor structure according to the present invention described above, the first and second rotors 120 and 130 are turned by the wind to generate the power for driving the power generating device 170.

If the direction of the wind is changed, the first and second rotors 120 and 130 and the guide member 140 are turned with the main shaft 160, so that the direction of the first and second rotors is changed.

As described above, if the guide member 140, the first and second rotors 120 and 130, and the main shaft 160 are turned so as to be against the wind, the wind flowing between the first and second rotors 120 and 130 flows towards the front of the first and second rotors 120 and 130 along both sides of the guide member 140. In this instance, the first and second rotors 120 and 130 are against the wind blowing from the front and the wind guided by the guide member 140, thereby generating the rotational force. The eccentric dual rotor structure according to the present invention has an advantage of utilizing the wind blowing from the front of the first and second rotors 120 and 130 when generating the power.

When the first rotor 120 and the second rotor 130 are turned, the first rotor 120 and the second rotor 130 are rotated in cooperation with the connecting rod 181 or gear train 182.

Since the first timing pulley 151 installed to the first rotation shaft 121 or the second rotation shaft 131 are connected to the second timing pulley 152 installed to the power transmitting shaft 153 by the timing belt 154, the rotational force of the first and second rotors 120 and 130 is transmitted to the power transmitting shaft 153, and thus the power transmitting shaft 153 is rotated. The rotational force of the power transmitting shaft 153 is transmitted to the power generating device 170 to generate the electricity.

Although preferred embodiments of the present invention have been described for illustrative purposes, those skilled in the art will appreciate that various modifications, additions and substitutions are possible, without departing from the scope and spirit of the invention as disclosed in the accompanying claims.

1. An eccentric dual rotor assembly for wind power generation, comprising:
a supporting structure which rotatably supports a main shaft;
a first rotor including a cylindrical first rotating frame installed to a first rotation shaft which is rotatably supported by a support bar extending from the main shaft, and a plurality of first wing assemblies provided on an outer surface of the first rotating frame, in which wind power acts on the first wing assemblies to rotate the first rotating frame in a forward direction;
a second rotor having a structure symmetrical to the first rotor, and including a cylindrical second rotating frame installed to the second rotation shaft which is rotatably supported by another support bar extending from the main shaft, and a plurality of second wing assemblies provided on an outer surface of the second rotating frame, in which wind power acts on the second wing assemblies to rotate the second rotating frame in a reverse direction;
a guide member which is installed to the main shaft so as to position in front of the main shaft, in which wind flowing between the first and second rotors is guided to front surfaces of the first and second rotors by the guide member; and
a power-transmitting means which transmits power generated by rotation of the first and second rotors to a power generating device.

2. The eccentric dual rotor assembly for wind power generation according to claim 1, wherein the guide member is positioned in front of the main shaft, and the first and second rotors are symmetrically placed on the basis of a line connecting a center of the guide member and a center of the main shaft at the rear of the main shaft, so that the guide member and the first and second rotors are turned with the main shaft to change directions of the guide member and the first and second rotors in accordance with a direction of the wind.

3. The eccentric dual rotor assembly for wind power generation according to claim 1, wherein the first rotor and the second rotor are connected to each other by a power combining unit to turn in cooperation with each other, and
any one of the first and second rotation shafts transmits the power to the power generating device via the power-transmitting means.

4. The eccentric dual rotor assembly for wind power generation according to claim 3, wherein the power combining unit is a connecting rod or a gear train.

5. The eccentric dual rotor assembly for wind power generation according to claim 3, wherein the power-transmitting means includes a first timing pulley installed to the first rotation shaft or the second rotation shaft, a power transmitting shaft which encloses the main shaft to form a dual-shaft structure, is rotated around the main shaft, and is coupled to the power generating device to transmit the power to the power generating device, a second timing pulley provided to the power transmitting shaft, and a timing belt connecting the first and second timing pulley.

6. The eccentric dual rotor assembly for wind power generation according to claim 1, wherein the first wing assembly of the first rotor has a plurality of first wing fixing portions protruding from the first rotating frame, a plurality of resilient first wing fixing plates each fixed to the first wing fixing portion, and a plurality of first wings each fixed to one side of the first wing fixing plate at a center portion and an end portion to open or close a first space formed between the first wing fixing portions, in which one end portion of the first wing protrudes outwardly from the first rotating frame when the first rotating frame is rotated to open the first space, and
the second wing assembly of the second rotor has a plurality of second wing fixing portions protruding from the second rotating frame, a plurality of resilient second wing fixing plates each fixed to the second wing fixing portion, and a plurality of second wings each fixed to one side of the second wing fixing plate at a center portion and an end portion to open or close a second space formed between the second wing fixing portions, in which one end portion of the second wing protrudes outwardly from the second rotating frame when the second rotating frame is rotated to open the second space.

7. The eccentric dual rotor assembly for wind power generation according to claim 1, wherein the supporting structure includes
an upper-end portion supporting section which is formed in a plane structure of a regular pentagon having left and right upper sides, left and right lower sides, and a base side to rotatably support an upper end portion of the main shaft;
a lower-end portion supporting section which is formed in a plane structure of a regular pentagon having left and right upper sides, left and right lower sides, and a base side to rotatably support a lower end portion of the main shaft, in which the lower-end portion supporting section has an inverted pentagon immediately below the upper-end portion support section; and
a plurality of connection sections which connect each apex of the upper-end portion supporting section and the lower-end portion supporting section to connect any one apex of the upper-end portion supporting section and two apexes of the lower-end portion supporting section, thereby forming several sides having a triangular truss structure.

8. The eccentric dual rotor assembly for wind power generation according to claim 4, wherein the power-transmitting means includes a first timing pulley installed to the first rotation shaft or the second rotation shaft, a power transmitting shaft which encloses the main shaft to form a dual-shaft structure, is rotated around the main shaft, and is coupled to the power generating device to transmit the power to the power generating device, a second timing pulley provided to the power transmitting shaft, and a timing belt connecting the first and second timing pulley.
